(19) United States
(12) Patent Application Publication
(10) Pub. No.: US 2014/0045050 A1
(43) Pub. Date: Feb. 13, 2014

(54) NONAQUEOUS ELECTROLYTE SECONDARY BATTERY

(71) Applicant: SANYO Electric Co., Ltd., Moriguchi-shi (JP)

(72) Inventors: Takayuki Hattori, Minamiawaji-shi (JP); Yoshinori Yokoyama, Itano-gun (JP); Eiji Okutani, Kasai-shi (JP); Yasuhiro Yamauchi, Sumoto-shi (JP)

(73) Assignee: SANYO Electric Co., Ltd., Moriguchi-shi (JP)

(21) Appl. No.: 13/962,027

(22) Filed: Aug. 8, 2013

(30) Foreign Application Priority Data
Aug. 9, 2012 (JP) 2012-176790

(51) Int. Cl. H01M 10/0563

(52) U.S. Cl. CPC H01M 10/0563
USPC 429/185; 429/163

(57) ABSTRACT

A nonaqueous electrolyte secondary battery according to an embodiment of the present invention includes an electrode assembly, a nonaqueous electrolyte, and a metallic container. The electrode assembly includes a positive electrode, a negative electrode, and a separator. The negative electrode is opposed to the positive electrode. The separator is disposed between the positive electrode and the negative electrode. The nonaqueous electrolyte contains lithium bis(oxalato)borate (LiBOB). The container houses the electrode assembly and the nonaqueous electrolyte. At least part of the container has positive electrode potential.

### TECHNICAL FIELD

The present invention relates to a nonaqueous electrolyte secondary battery.

### BACKGROUND ART

In recent years, there have been various endeavors to use nonaqueous electrolyte secondary batteries in, for example, electric vehicles, hybrid cars, and the like. In such applications, the batteries are strongly required to have long life in addition to high output.

For example, JP-A-2009-245828 states that the cycling life of a nonaqueous electrolyte secondary battery is improved by adding lithium bis(oxalato)borate (LiBOB) to its nonaqueous electrolyte.

The inventors of the present invention have discovered, as a result of diligent researches, that in some cases the cycling life of nonaqueous electrolyte secondary batteries cannot be adequately improved even though LiBOB is added to their nonaqueous electrolyte. The inventors have arrived at the invention as a result of this discovery.

### SUMMARY

A principal advantage of some aspects of the invention is to provide a nonaqueous electrolyte secondary battery that has improved cycling life.

A nonaqueous electrolyte secondary battery of an aspect of the invention includes an electrode assembly, a nonaqueous electrolyte, and a metallic container. The electrode assembly includes a positive electrode, a negative electrode, and a separator. The negative electrode is opposed to the positive electrode. The separator is disposed between the positive electrode and the negative electrode. The nonaqueous electrolyte contains lithium bis(oxalato)borate (LiBOB). The container houses the electrode assembly and the nonaqueous electrolyte. At least part of the container has positive electrode potential.

The invention enables provision of a nonaqueous electrolyte secondary battery that has improved cycling life.

### BRIEF DESCRIPTION OF THE DRAWINGS

The invention will be described with reference to the accompanying drawings, wherein like numbers reference like elements.

FIG. 1 is a simplified perspective view of a nonaqueous electrolyte secondary battery according to an embodiment of the invention.

FIG. 2 is a simplified sectional view through line II-II in FIG. 1.

FIG. 3 is a simplified sectional view through line III-III in FIG. 1.

FIG. 4 is a simplified sectional view through line IV-IV in FIG. 1.

FIG. 5 is a simplified sectional view of part of the electrode assembly in an embodiment of the invention.

### DESCRIPTION OF EXEMPLARY EMBODIMENTS

A preferred embodiment that implements the invention will now be described with reference to the accompanying drawings. However, the following embodiment is merely an illustrative example and does not limit the invention in any way.

In the accompanying drawings, to which reference will be made in describing the embodiment and other matters, members that have substantially the same functions are assigned the same reference numerals throughout. In addition, the accompanying drawings, to which reference will be made in describing the embodiment and other matters, are schematic representations, and the proportions of the dimensions of the objects depicted in the drawings may differ from the proportions of the dimensions of the actual objects. The proportions of the dimensions of the objects may differ among the drawings. The concrete proportions of the dimensions of the objects should be determined in view of the following description.

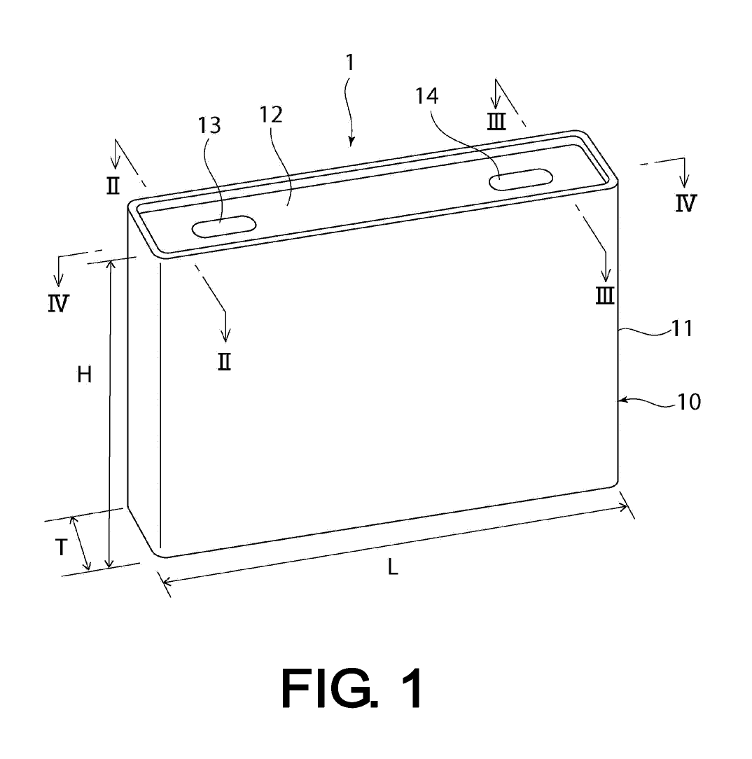

A nonaqueous electrolyte secondary battery 1 shown in FIG. 1 is a prismatic nonaqueous electrolyte secondary battery. The nonaqueous electrolyte secondary battery 1 can be used for any kind of application, and will preferably be used in an electric vehicle and a hybrid vehicle, for example. The capacity of the nonaqueous electrolyte secondary battery 1 is not less than 15 Ah, further preferably not less than 18 Ah, and still further preferably not less than 20 Ah. Normally, the capacity of the nonaqueous electrolyte secondary battery 1 will be not more than 50 Ah.

The “battery capacity” in this case means the capacity of the battery when the battery has been charged at a constant current of 1 It to a voltage of 4.1 V, then charged for 1.5 hours at a constant voltage of 4.1 V, and then discharged at a constant current of 1 It to a voltage of 2.5 V.

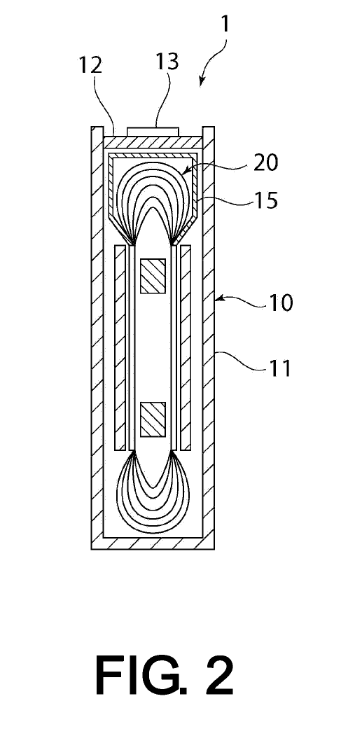

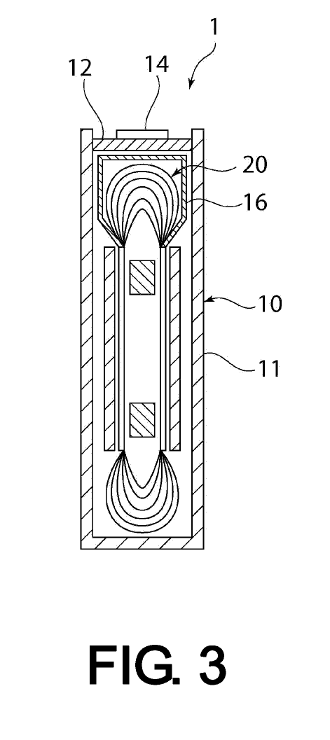

The nonaqueous electrolyte secondary battery 1 includes a container 10 shown in FIGS. 1 to 4, and an electrode assembly 20 shown in FIGS. 2 to 5. The nonaqueous electrolyte secondary battery 1 is a prismatic nonaqueous electrolyte secondary battery in which the container 10 is prismatic (parallelepiped) in shape. The surface area of the inside wall of the container 10 will preferably be not less than 200 cm², further preferably not less than 300 cm², and still further preferably not less than 350 cm². The length dimension L of the container 10 will preferably be 100 to 200 mm, and further preferably will be 140 to 180 mm. The thickness dimension T of the container 10 will preferably be 10 to 30 mm, and further preferably will be 20 to 28 mm. The height dimension H of the container 10 will preferably be 75 to 100 mm, and further preferably will be 80 to 95 mm. The ratio of the length dimension L of the container 10 to its height dimension H (L/H) will preferably be 1.5 to 2.5, and further preferably will be 1.8 to 2.2.

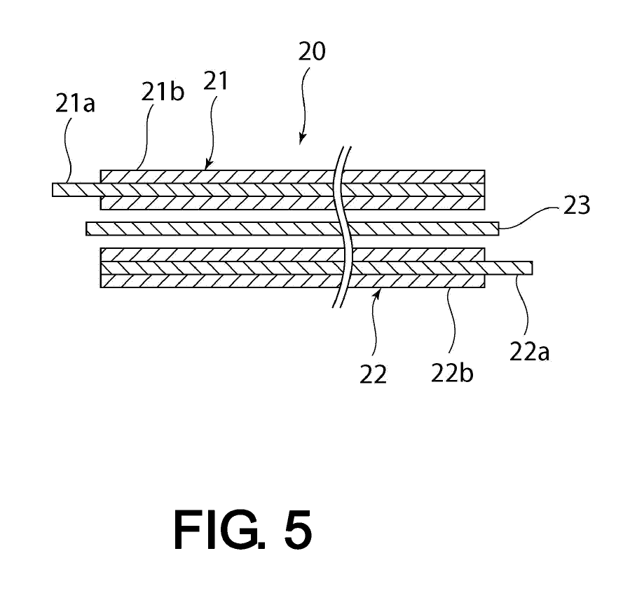

As shown in FIG. 5, the electrode assembly 20 includes the positive electrode 21, the negative electrode 22, and a separator 23. The positive electrode 21 and the negative electrode 22 are opposed to each other. The separator 23 is disposed between the positive electrode 21 and the negative electrode 22. The positive electrode 21, the negative electrode 22, and the separator 23 are wound and then pressed into a flattened shape. In other words, the electrode assembly 20 includes a flat wound positive electrode 21, negative electrode 22, and separator 23.

The positive electrode 21 includes a positive electrode substrate 21a and a positive electrode active material layer 21b. The positive electrode substrate 21a can be formed of aluminum, an aluminum alloy, or other materials. The positive electrode active material layer 21b is provided on at least one surface of the positive electrode substrate 21a. The positive electrode active material layer 21b contains a positive electrode active material. An example of the positive electrode active material that will preferably be used is a lithium oxide containing at least one of cobalt, nickel, and manganese. The following shows specific examples of such a lithium oxide containing at least one of cobalt, nickel, and manganese: lithium-containing nickel-cobalt-manganese complex oxides (LiNiₓCo_{y}Mn_{z}O₂, x+y+z=1, 0≦x≦1, 0≦y≦1, 0≦z≦1); lithium cobalt oxide (LiCoO₂); lithium manganese oxide (LiMn₂O₄); lithium nickel oxide (LiNiO₂); and a lithium-containing transition metal complex oxide such as a compound obtained by replacing part of the transition metal contained in these oxides with another element. Of these, lithium-containing nickel-cobalt-manganese complex oxides (LiNiₓCo_{y}Mn_{z}O₂, x+y+z=1, 0≦x≦1, 0≦y≦1, 0≦z≦1) and a lithium-containing transition metal complex oxide such as a compound obtained by replacing part of the transition metal contained in such oxide with another element will further preferably be used as the positive electrode active material. The positive electrode active material layer 21b may contain another component such as conductive material and binder as appropriate in addition to the positive electrode active material.

The negative electrode 22 includes a negative electrode substrate 22a and a negative electrode active material layer 22b. The negative electrode substrate 22a can be formed of copper, a copper alloy, or other materials. The negative electrode active material layer 22b is provided on at least one surface of the negative electrode substrate 22a. The negative electrode substrate 22a contains negative electrode active material. There is no particular limitation on the negative electrode active material, provided that it is able to reversibly absorb and desorb lithium. Examples of the negative electrode active material that will preferably be used are: carbon material, material that alloys with lithium, and metal oxide such as tin oxide. The following specific examples of carbon material can be cited: natural graphite, artificial graphite, mesophase pitch-based carbon fiber (MCF), mesocarbon microbeads (MCMB), coke, hard carbon, fullerene, and carbon nanotubes. Examples of material that can alloy with lithium are: one or more metals selected from the group consisting of silicon, germanium, tin, and aluminum, or an alloy containing one or more metals selected from the group consisting of silicon, germanium, tin, and aluminum. Of these, natural graphite, artificial graphite, and mesophase pitch-based carbon fiber (MCF) will preferably be used as the negative electrode active material. The negative electrode active material layer 22b may contain another component such as conductive material and binder as appropriate in addition to the negative electrode active material.

The separator can be formed of a porous sheet of plastic such as polyethylene and polypropylene.

The electrode assembly 20 is housed inside the container 10. The nonaqueous electrolyte is also housed inside the container 10. The nonaqueous electrolyte may contain lithium bis(oxalato)borate (LiBOB) as solute. The desirable additive amount of LiBOB in the interest of improving the cycling characteristics of the nonaqueous electrolyte secondary battery 1 will depend on the battery capacity of the nonaqueous electrolyte secondary battery 1. Specifically, a larger battery capacity of the nonaqueous electrolyte secondary battery 1 requires a larger desirable additive amount of LiBOB in the interest of improving the cycling characteristics of the nonaqueous electrolyte secondary battery 1. The battery capacity of the nonaqueous electrolyte secondary battery 1 is not less than 15 Ah. The content of LiBOB in the nonaqueous electrolyte of the nonaqueous electrolyte secondary battery 1 will preferably be not less than 0.05 mol/L, further preferably not less than 0.08 mol/L, and still further preferably not less than 0.10 mol/L, in the interest of improving the cycling characteristics of the nonaqueous electrolyte secondary battery 1. However, if the content of LiBOB in the nonaqueous electrolyte is too high, the nonaqueous electrolyte secondary battery 1 could heat up excessively when used. In addition, the battery characteristics could decline due to increase in the internal resistance of the battery. Hence, the content of LiBOB in the nonaqueous electrolyte of the nonaqueous electrolyte secondary battery 1 will preferably be not more than 2 mol/L, and further preferably not more than 1 mol/L.

These preferable content ranges for LiBOB are based on the nonaqueous electrolyte in the nonaqueous electrolyte secondary battery immediately after assembly and before the first charging. The reason for providing such basis is that when a nonaqueous electrolyte secondary battery containing LiBOB is charged, its content level gradually declines. The cause of this is supposed to be that during charging, part of the LiBOB is consumed in formation of a covering on the negative electrode.

In addition to LiBOB, the nonaqueous electrolyte may contain as solute a substance such as: LiXF_{y} (where X is P, As, Sb, B, Bi, Al, Ga, or In, and y is 6 when X is P, As, or Sb, and y is 4 when X is B, Bi, Al, Ga, or In); lithium perfluoroalkyl sulfonic acid imide LiN(CₘF₂ₘ₊₁SO₂)(CₙF₂ₙ₊₁SO₂) (where m and n are independently integers from 1 to 4); lithium perfluoroalkyl sulfonic acid methide LiC(CₚF₂ₚ₊₁SO₂)(C_{q}F_{2q+1}SO₂)(CᵣF₂ᵣ₊₁SO₂) (where p, q, and r are independently integers from 1 to 4); LiCF₃SO₃; LiClO₄; Li₂B₁₀Cl₁₀; and Li₂B₁₂Cl₁₂. Of these, the nonaqueous electrolyte may contain, as solute, at least one of LiPF₆, LiBF₄, LiN(CF₃SO₂)₂, LiN(C₂F₅SO₂)₂, LiN(CF₃SO₂)(C₄F₉SO₂), LiC(CF₃SO₂)₃, and LiC(C₂F₅SO₂)₃, for example. The nonaqueous electrolyte may contain as solvent, for example, cyclic carbonate, chain carbonate, or a mixture of cyclic carbonate and chain carbonate. Specific examples of cyclic carbonate are ethylene carbonate, propylene carbonate, butylene carbonate, and vinylene carbonate. Specific examples of chain carbonate are dimethyl carbonate, methylethyl carbonate, and diethyl carbonate.

The container 10 has a container body 11 and a sealing plate 12. The container body 11 and the sealing plate 12 are both made using metal. For example, the container body 11 and the sealing plate 12 can each be made using aluminum or stainless steel. “Stainless steel” refers to an iron alloy that contains at least chromium. Specific examples of such stainless steel are: an iron alloy that contains nickel, chromium, and manganese; an iron alloy that contains nickel and chromium; an iron alloy that contains nickel, chromium, and molybdenum; an iron alloy that contains chromium; an iron alloy that contains chromium and aluminum; an iron alloy that contains chromium, and titanium or niobium; and an iron alloy that contains nickel, chromium, copper, and niobium.

The container body 11 is provided in the form of a rectangular tube of which one end is closed. In other words, the container body 11 is provided in the form of a bottomed rectangular tube. The container body 11 has an opening. This opening is sealed up by the sealing plate 12. Thereby, the parallelepiped interior space is formed into a compartment. The electrode assembly 20 and the nonaqueous electrolyte are housed in this interior space.

The sealing plate 12 includes a positive electrode terminal 13 and a negative electrode terminal 14. The positive electrode terminal 13 and the negative electrode terminal 14 are each electrically insulated from the sealing plate 12 by insulating material not shown in the drawings.

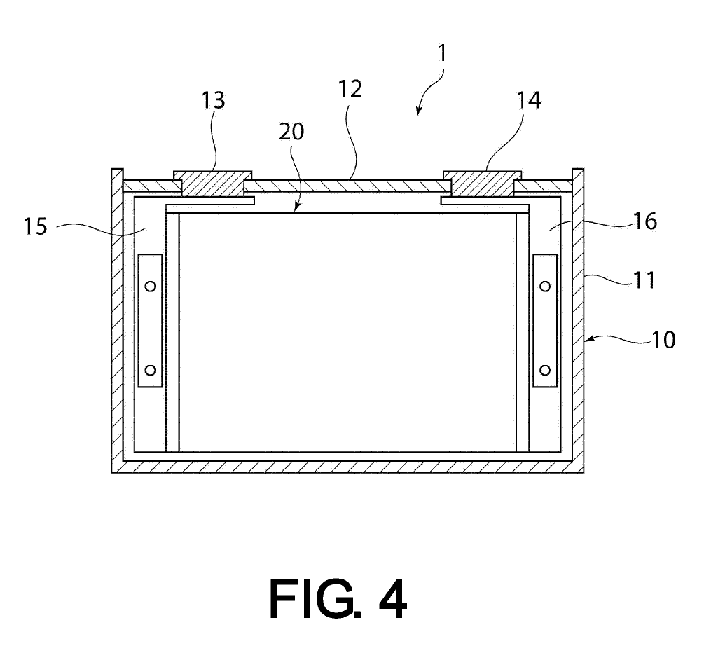

The positive electrode terminal 13 is electrically connected to a positive electrode substrate 21a of a positive electrode 21 by positive electrode collector 15 shown in FIG. 4. The positive electrode collector 15 can be formed of aluminum, an aluminum alloy, or other materials. The negative electrode terminal 14 is electrically connected to a negative electrode substrate 22a of a negative electrode 22 by negative electrode collector 16 shown in FIG. 4. The negative electrode collector 16 can be formed of copper, a copper alloy, or other materials.

As mentioned above, JP-A-2009-245828 states that the cycling life of nonaqueous electrolyte secondary batteries can in some cases be improved by adding LiBOB to their nonaqueous electrolyte. Yet, the inventors have discovered, as a result of diligent researches, that in some cases the cycling life of nonaqueous electrolyte secondary batteries cannot be adequately improved even though LiBOB is added to their nonaqueous electrolyte. The reasons for this are not certain, but are probably as follows. When LiBOB is added to the nonaqueous electrolyte, the initial charge-discharge cycling causes a LiBOB-derived covering to be formed on the negative electrode active material layer, resulting in improvement of the cycling characteristics and storage characteristics. However, relative to the volume of LiBOB initially prepared, the content of LiBOB decreases by the amount of LiBOB that is consumed by the covering formation. In the case where the container has negative electrode potential, a LiBOB-derived covering will also be formed on the inside wall of the container. In such case, a LiBOB-derived covering will not be formed in a favorable manner on the negative electrode active material, and as a result, the cycling characteristics and storage characteristics will not be adequately enhanced, despite LiBOB having been added. In particular, with a large battery capacity of 15 Ah and over and a large surface area of 200 cm² or over of the inside wall of the container, LiBOB is consumed in forming a LiBOB-derived covering on the inside wall of the container. This means that a LiBOB-derived covering will not be adequately formed on the negative electrode active material, and the cycling characteristics and storage characteristics will tend to be unlikely to be enhanced.

In the nonaqueous electrolyte secondary battery 1, at least part of the container 10 is electrically connected to the positive electrode 21, so as to have negative electrode potential. This effectively prevents the potential of the container 10 from being negative potential. Hence, a LiBOB-derived covering will be unlikely to be formed on the inside wall of the container 10, and a LiBOB-derived covering will be formed in a favorable manner on the negative material active layer 22b. Thus, it will be possible to improve cycling characteristics and storage characteristics. In the interest of further improving cycling characteristics and storage characteristics, at least the container body 11 of the container 10 will preferably have positive electrode potential, and further preferably, substantially the whole of the container 10 will have positive electrode potential.

Furthermore, in the nonaqueous electrolyte secondary battery 1, a LiBOB-derived covering will be unlikely to be formed on the inside wall of the container 10, which means that the additive amount of LiBOB can be small. Thus, the decline in thermal stability due to addition of LiBOB to the nonaqueous electrolyte can be prevented in the nonaqueous electrolyte secondary battery 1.

It will suffice for LiBOB to be present in the electrolyte immediately after the nonaqueous electrolyte secondary battery has been assembled. For example, after charge-discharge has been performed following assembly, the LiBOB may in some cases be present in the form of a LiBOB alteration. In other cases, at least a part of the LiBOB or the LiBOB alteration may be present on the negative electrode active material layer. Such cases are included in the technical scope of the invention.

What is claimed is:

1. A nonaqueous electrolyte secondary battery, comprising:
an electrode assembly including a positive electrode, a negative electrode opposed to the positive electrode, and a separator disposed between the positive electrode and the negative electrode;
a nonaqueous electrolyte containing lithium bis(oxalato)borate (LiBOB); and
a metallic container housing the electrode assembly and the nonaqueous electrolyte,
at least part of the container having positive electrode potential.

2. The nonaqueous electrolyte secondary battery according to claim 1, wherein
the container has:
a container body that is a bottomed rectangular tube in shape and
a sealing plate that seals an opening of the container body and includes a positive electrode terminal electrically connected to the positive electrode and a negative electrode terminal electrically connected to the negative electrode, and
at least the container body of the container has positive electrode potential.

3. The nonaqueous electrolyte secondary battery according to claim 1, wherein the battery capacity is not less than 15 Ah.

4. The nonaqueous electrolyte secondary battery according to claim 2, wherein the battery capacity is not less than 15 Ah.

5. The nonaqueous electrolyte secondary battery according to claim 1, wherein the surface area of the inside wall of the container is not less than 200 cm².

6. The nonaqueous electrolyte secondary battery according to claim 2, wherein the surface area of the inside wall of the container is not less than 200 cm².

7. The nonaqueous electrolyte secondary battery according to claim 3, wherein the surface area of the inside wall of the container is not less than 200 cm².

8. The nonaqueous electrolyte secondary battery according to claim 4, wherein the surface area of the inside wall of the container is not less than 200 cm².
